(19) United States
(12) Patent Application Publication
(10) Pub. No.: US 2002/0002668 A1
(43) Pub. Date: Jan. 3, 2002

(54) PROGRAM EXECUTION METHOD FOR SPECIFIC CASE PROCESSING AND APPARATUS USING THE SAME

(76) Inventors: HIROKI MIURA, WARABI-SHI (JP); YASUHITO KOUMURA, TOKYO (JP); KENSHI MATSUMOTO, KOSHIGAYA-SHI (JP)

Correspondence Address: WEI-FU HSU, ESQ., HOGAN & HARTSON, L.L.P., 500 SOUTH GRAND AVENUE, SUITE 1900, BILTMORE TOWER, LOS ANGLES, GA, 90071, US

(21) Appl. No.: 08/784,753

(22) Filed: Jan. 16, 1997

(30) Foreign Application Priority Data
Jan. 19, 1996 (JP) 8-006971

(51) Int. Cl. G06F 7/38; G06F 9/00; G06F 9/44; G06F 15/00

(52) U.S. Cl. 712/244

(57) ABSTRACT

When a process branches to an interrupt processing routine, the value stored in a return address holding register ERP is transferred to a register R2 via the initial MOVS instruction. Upon the next SETPR instruction (an acceptable interrupt level setting instruction), an EA (interrupt allowance) flag is automatically set at 1, whereby multiple interrupts are allowed. For process returning, the value saved in the register R2 is transferred to the ERP register via a data transfer instruction MOVS, upon which the EA flag is automatically set at 0 to thereby inhibit receipt of interrupt requests. Upon execution of the last RETI instruction, receipt of interrupt requests is again allowed.

### BACKGROUND OF THE INVENTION

1. Description of the Prior Art

The present invention relates to a program execution method and a program execution apparatus using this method. This method and apparatus particularly execute specific processing, such as an exception handling, in addition to normal processing, according to requests supplied from the inside or the outside of the apparatus. This program execution apparatus is applicable to a microprocessor, or the like.

2. Field of the Invention

Conventionally, there have generally been available a number of program execution apparatuses, including microprocessors, of a control driven type which successively fetches instructions from a memory and decodes them for program execution. Recently, microprocessors have been improved such that they can perform high-speed interrupt processing in response to externally supplied interrupt signals or high-speed exception processing accompanying the occurrence of exceptions, such as internal errors of a processor.

[1] Return Pointer Register

one example of the improvement is a method using a hardware return pointer. This register stores a return address from interrupt or exception processing (hereinafter also referred to as “interrupt processing, or the like”). To be more specific, when interrupts or exceptions (hereinafter also referred to as “an interrupt, or the like”) occur, the return point register stores a return address before the process branches to a designated interrupt processing routine, or the like (hereinafter also referred to as “a processing routine”). With the processing routine completed, the return pointer register value is loaded on a program counter to go back to the main routine. A return pointer register allows high speed processing, eliminating the need to access stack memory. However, a return pointer register is disadvantageous in that it requires larger hardware, compared to a memory using a general stack method, and thus only a single unit can generally be provided at most.

[2] Return Pointer Register and Multiple Interrupts

In the case of a sole return pointer register, consideration must be paid to accept another interrupt while the current interrupt processing is in progress, in other words, to achieve multiple interrupts. That is, for general multiple interrupts, the return pointer register value is pushed in a stack memory or a general register at the start of a processing routine and is popped into the return pointer register at the end thereof before the process returns from the processing routine. In this event, however, the return pointer register value is saved at no point during the following periods (hereinafter referred to as “a critical period”):

(1) a period from storing a return address into a return pointer register upon occurrence of an interrupt to completion of pushing of the return address; and

(2) a period from storing the return address which has been pushed into the return pointer to completion of execution of a return instruction.

Provided that another interrupt occurs during a critical period, the return pointer register value is overwritten by a new return address, eliminating the return address from the ongoing interrupt processing. As a result, the process cannot return properly. It is thus necessary to disable multiple interrupts at least during the above critical periods.

[3] Multiple Interrupts in Conventional Processors

According to “A Users' Manual: v810 32-bit Microprocessor μPD70732” (September 1993) for a microprocessor V810 manufactured by NEC, pages 67 to 69, 151, 162, and 164, multiple interrupts have been achieved as follows.

(1) EIPC Register

An EIPC register is a return pointer register which saves the content of a program counter (PC) when an interrupt occurs.

(2) EP Flag

An EP flag is provided within a program status word (PSW), which is one of the system status registers, and distinguishes critical periods from safe periods. An EP flag is automatically set upon occurrence of exceptions, including interrupts, whereby interrupts are masked. While an EP flag is 1, an interrupt signal is disregarded.

(3) EIPSW Register

Upon occurrence of interrupts, an EIPSW register stores the PSW value.

Upon receipt of an interrupt request, the PC value and the PSW value are respectively transferred to be stored in EIPC and EIPSW registers, and an EP flag is set 1. With the interrupt processing completed, the EIPC register value and the EIPSW register value are respectively stored back in the PC and PSW via a return instruction (an RETI instruction), and the process returns to the address indicated by the PC. Execution of the RETI instruction also makes the status of the EP flag what it was before the occurrence of the interrupt.

This is the basic operation for handling interrupts. However, when multiple interrupts occur in this system, an EP flag will always be 1 (EP=1) during the entire execution of an interrupt processing routine, and no multiple interrupts can thus be accepted during such a period. In order to solve this deficiency, this processor uses an instruction for loading data into a system register (an LDSR instruction). This instruction, generally used for writing data into various system registers, includes a two-register operand so that the value of a register designated by the first operand is transferred to a register designated by the second operand, such as a PSW register. In order to allow multiple interrupts, this processor transfers the EIPC register value after the process has branched to a processing routine, and then writes predetermined data into the PSW via an LDSR instruction to make the EP flag 0. The processor is then, once again, in a state which allows interrupts, or the like.

For process returning, the EP flag is first turned to 1 via an LDSR instruction. The processor then enters into the state which inhibits interrupts. The processor then transfers the value which has been saved back into the EIPC register.

An example of an interrupt processing routine for the above processor is shown below.

| | | |
|---|---|---|
| STSR | EIPSW,r1 | (r1<-EIPSW) |
| STSR | EIPC,r2 | (r2<−EIPC) |
| MOVHI | 5,r0,r3 | (r3<−50000H) |
| LDSR | r3,PSW | (PSW<−r3) |

:

interrupt processing

:

| | | |
|---|---|---|
| ORI | 4000H,r0,r3 | (r3<−4000H) |
| LDSR | r3,PSW | (PSW<−r3) |
| LDSR | r1,EIPSW | (EIPSW<−rl) |
| LDSR | r2,EIPC | (EIPC<−r2) |
| RETI | | (PC<−EIPC,PSW<−EIPSW) |

In this program, the values in the EIPSW and EIPC registers are transferred to general registers via the first two instructions. (The values may be saved in a memory, though a register is applied here for convenience of explanation.) At the MOVHI instruction, a value to be written into the PSW register is formed in a general register r3. The usage of an MOVHI instruction is unique to this processor. In the above example, the lower sixteen bits of the 32-bit are allotted to represent r0, which is always recognized as 0 by the processor, and the upper sixteen bits are allotted to represent the immediate value “5.” Resultantly, the register r3 stores the value “50000H.” At the subsequent LDSR instruction, “50000H” is stored in the PSW. In this processor, the 14th bit of the PSW register is an EP flag bit, and the 16th to 19th bits relate to an interrupt enable level. Thus, by executing the above LDSR instruction, the EP flag becomes 0 (interrupts enabled), while an interrupt enable level is set at 5.

After interrupt processing is completed and before the process returns, a value to be written into the PSW register is formed in the register r3 via an ORI instruction. That is, a logical OR of an immediate value “4000H” and r0 (similarly recognized as 0 by the processor) is stored in the register r3. When the register r3 value is written into the PSW via a subsequent LDSR instruction, the EP flag in the PSW register is set to 1 to thereby inhibit further interrupts. At the following two instructions, the EIPSW and EIPC registers respectively receive relevant values which have been saved in other registers, and the RETI instruction is subsequently executed.

As described above, this processor uses LDSR instructions for enabling or disabling multiple interrupts.

The foregoing conventional processor has room for improvement as follows.

1. An LDSR instruction must be executed just to change the status of an EP flag. This causes an increased number of program steps and instructions, a longer processing time, and a larger program size for an interrupt routine.

2. Since an LDSR instruction is not exclusive to changing an EP flag status, data to be transferred must be formed by using MOVHI, ORI, or suchlike instructions. This further increases the number of steps and instructions.

3. A PSW register additionally stores operation flags or suchlike which have nothing to do with interrupt processing. Thus, changing only the flag status needed to be changed out of all the flags requires additional steps for executing instructions not shown in the foregoing program example, such as mask operations.

4. For the same reason as the above 3, when operation flags, etc., are required to be preserved, the positions of those flags must be taken into account in programming. This will complicate programming operations and will tend to cause careless mistakes.

5. Even in a safe period, interrupt requests must wait to be accepted until completion of execution of an LDSR instruction. An urgent external interrupt signal may thus be forcibly delayed too long.

### SUMMARY OF THE INVENTION

The present invention has conceived to overcome the above problems and aims to provide a program execution method and apparatus for reducing program size and processing time of a processing routine and responding time for interrupt processing, or the like.

(1) A program execution method according to one aspect of the present invention comprises steps of receiving a request for specific case processing during execution of the normal processing; upon receipt of a request for specific case processing, temporarily inhibiting further receipt of a request for specific case processing and branching to a routine for the specific case processing and storing a return address for use in returning to the normal processing in address holding means; saving the return address stored in the address holding means in address saving means during the routine; and automatically allowing further receipt of a request for specific case processing when an instruction for preparing environment for allowing further receipt of a request is executed.

“Normal processing” means processing performed in as a program main routine, or the like. “Specific cases processing” means processing branched from the normal processing. It includes a subroutine and processing using interrupt handlers or exception handlers. “Specific cases” is a concept covering all the cases which are to be handled while having a return address stored and the main processing suspended. It includes interrupts, exceptions, etc., done by a processor, or the like. A typical example of “an address holding section” is a foregoing return pointer register. “An address saving section” saves the return pointer register value so as to allow multiple interrupts, or the like. It includes a stack memory, a general register, or suchlike. “An instruction for preparing environment” refers to an instruction aiming literally for preparation and does not include an instruction for explicitly allowing the receipt of requests, such as an enable interrupt instruction.

(2) In another aspect of the present invention, a program execution method comprises steps of, after a process has branched to a specific case processing routine, saving the return address stored in the address holding means in address saving means during the routine; executing the specific case processing while allowing further receipt of a request for specific case processing; and automatically inhibiting further receipt of a request for specific case processing when an instruction for preparing environment for returning to the normal processing is executed after completion of the specific case processing.

“An instruction for preparing environment” refers to an instruction aiming literally for preparation and does not include an instruction for explicitly inhibiting the receipt of requests, such as an disable interrupt instruction. Upon the start of preparation for process returning, a return address is retrieved from the address saving section and stored in the address holding section. If a further request for specific case processing is accepted at this stage, the content of the address holding section might be overwritten. In order to avoid such a critical situation, further requests are ignored for the moment.

(3) A program execution apparatus according to one aspect of the present invention comprises a setting section for setting allowance or rejection of receipt of a request for specific case processing, wherein the receipt is automatically allowed irrespective of a current setting situation when an acceptable interrupt level setting instruction is executed.

The requests can be accepted again because it is assumed that the apparatus is in the state of allowance when an interrupt receipt priority level is changed.

(4) In another aspect of the present invention, a program execution apparatus comprises a setting section for setting allowance or rejection of receipt of a request for specific case processing; an address holding section for storing a return address when a process branches to specific case processing; and an address saving section for saving a return address stored in the address holding section; wherein the setting section automatically rejects further receipt irrespective of a current setting situation when a return address read from the address saving section is stored in the address holding section.

In a further aspect of the present invention, a program execution apparatus comprises a setting section, an address holding section, and an address saving section, and executes the same processing as described in (1) or (2) above.

(5) In a still further aspect of the present invention, a program execution apparatus comprises an address holding section; an address saving section; and a status discrimination section for discriminating between an update allowed state where the contents of the address holding section is allowed to be updated and an update inhibited state where it is inhibited, wherein the program execution apparatus in the update inhibited state enters into the update allowed state when acceptable interrupt level setting instruction is executed.

(6) In a still further aspect of the present invention, the program execution apparatus in the update allowed state enters into the update inhibited state when a return address is saved in the address holding section.

The apparatus is thus shifted to the update inhibited state because acceptance of a request at this stage would result in the update of the stored return address.

In a still further aspect of the present invention, the status discrimination section is a flag bit capable of being manipulated by software, and the program execution apparatus shifts between the update allowed state and the update inhibited state by explicit or automatic re-writing of the flag bit.

“Explicit re-writing” is performed by coding, in a program an instruction for re-writing a flag bit itself. “Automatic re-writing” means re-writing which is not caused by an explicit instruction. This corresponds to a case where a flag bit is re-written by means of hardware at the moment when the process branches to a specific case processing routine.

### BRIEF DESCRIPTION OF THE DRAWINGS

The above and the other objects, features, and advantages, will become further apparent from the following description of the preferred embodiment taken in conjunction with the accompanying drawings wherein:

FIG. 1 is a diagram showing the overall structure of a program execution apparatus according to a preferred embodiment;

FIG. 2 is a diagram showing the structure of a status register (STAT) 14;

FIG. 3 is a flowchart showing a processing procedure for an interrupt, or the like, of the present apparatus;

FIG. 4 is a flowchart showing a processing procedure for an interrupt, or the like, of the present apparatus;

FIG. 5 is a table representing a method for determining whether to accept or ignore interrupt requests;

FIG. 6 is a table representing correlation between the types of an interrupt, or the like, detected by an interrupt/exception controller 13 and branch addresses (handler addresses); and

FIG. 7 shows an example of a program for an interrupt processing routine executed by the present apparatus.

### DESCRIPTION OF THE PREFERRED EMBODIMENTS

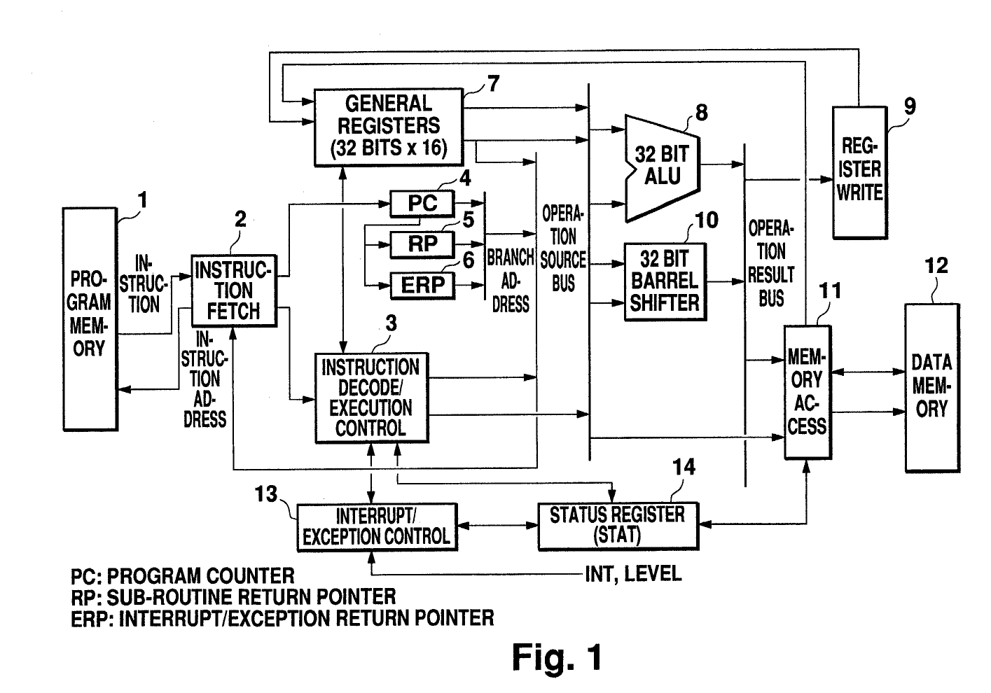

A preferred embodiment of a program execution apparatus of the present invention will be described. This description will also explicate a program execution method of the present invention. FIG. 1 is a diagram showing the overall structure of a program execution apparatus according to a preferred embodiment of the present invention. In the following embodiment, the apparatus may be a microprocessor.

[1] Overall Structure and Operations

Referring to FIG. 1, a program memory 1 stores instructions, such as data transfer instructions (load instructions, store instructions) and ALU operation instructions. Those instructions are successively fetched by an instruction fetch section 2 and further supplied to an instruction decode/execution controller 3. The instruction fetch section 2 also supplies instruction fetch addresses to a program counter (PC) 4 to be stored therein. The PC 4 is incremented every time an instruction is fetched. The PC 4 supplies a return pointer (RP) 5 and an interrupt/exception return pointer (ERP) 6 with a return address from a sub-routine and a return address from interrupt or exception processing, respectively. A branch address is selected from those stored in the PC, RP, and ERP, and one is formed through instruction decoding and used as an address for the next instruction and as a value to be set in the PC.

The instruction decode/execution controller 3 divides instruction code into fields according to the type of the instructions, so that an operation indicating the type of an ALU operation to be executed, an immediate operand that is included in an instruction code, a source register number, a destination register number, etc., are extracted from the instruction code. Register value is then read from a source register within general registers 7, designated by the extracted source register number.

If the type of an operation indicated by the extracted operation is addition or subtraction, a 32-bit ALU 8 executes the indicated operation, following the extracted operation and using the obtained source operand. The operation result is written into a destination register within the general registers 7 designated by a destination register number, via a register write section 9. For a shift operation, a 32-bit barrel shifter 10 executes the operation, following the extracted operation and using the obtained source operand. For an operation of storing data into a memory, data read from the general registers 7 is written into a data memory 12 via a memory access section 11, referring to a data address formed by the ALU 8. For an operation of loading data from a memory, data is read from the data memory 12, referring to a data address formed by the ALU 8, and written into a register within the general registers 7 designated by the instruction.

The interrupt/exception controller 13 receives an externally supplied interrupt signal (INT) and interrupt priority level (LEVEL), and executes a predetermined interrupt/exception control in accordance with the status register (STAT) 14 value and the status of the instruction decode/execution controller 3.

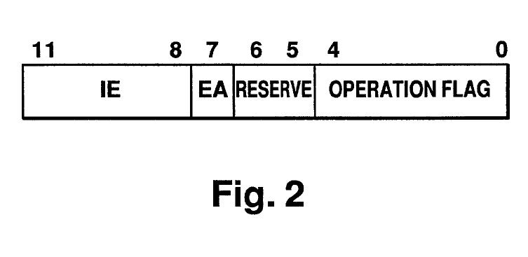

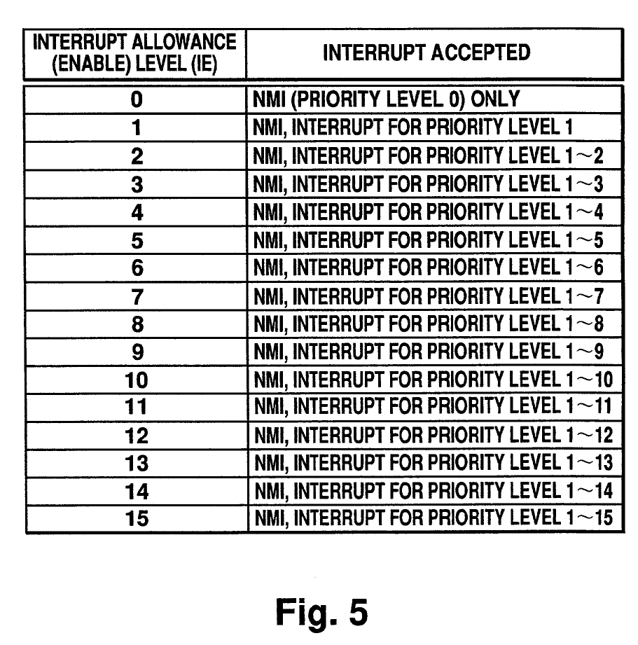

FIG. 2 is a diagram exemplifying the structure of a status register 14, in which IE represents an interrupt enable level which varies from 0 to 15. The present apparatus compares the LEVEL externally supplied and IE so as to decide whether or not to serve an interrupt. FIG. 5 is a table showing a method for determining whether to accept or ignore interrupts, which is used by the interrupt/exception controller 13. Non-maskable interrupts are denoted as NMI.

Referring again to FIG. 2, an Exception Acceptable (EA) is an exception processing status flag which shows 1 for enabling interrupt processing, or the like, and 0 for disabling. These two statuses of this flag correspond to a safe period and a critical period, respectively. The status register 14 also stores a 5-bit operation flag.

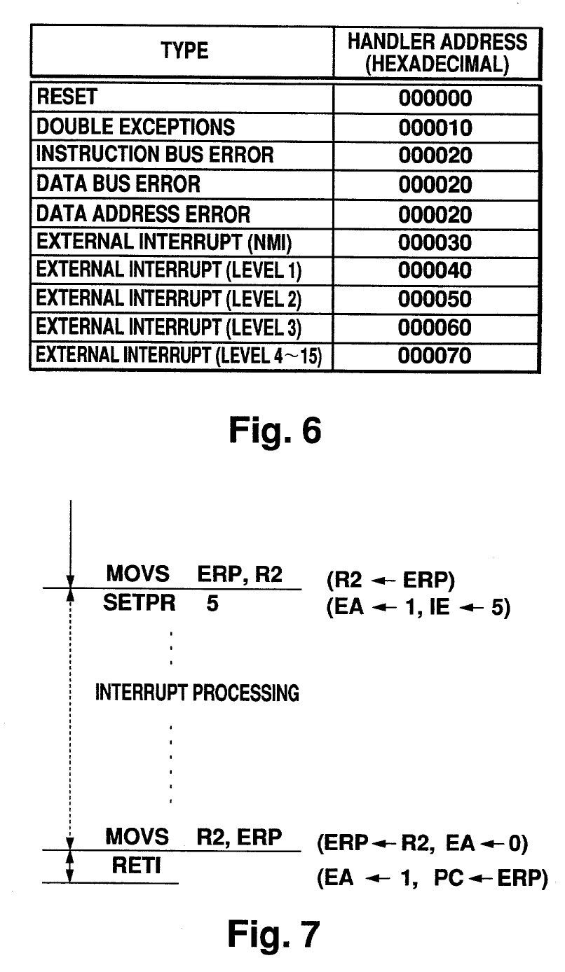

FIG. 6 is a table showing the correlation between the type of an interrupt, or the like, detected by the interrupt/exception controller 13 and a branch address (a handler address). The types are roughly classified into the following.

1. Reset

Responding to an externally supplied reset signal, all of the internal status is initialized, starting at the address “000000H.”

2. External Interrupt (16 levels)

Responding to an externally supplied interrupt signal of a maximum of 16 levels, including an NMI, a process jumps to a specified address, branching to a processing routine starting therefrom.

3. Data Address Error Exception

A process jumps to a specified address upon detection of illegal data access when a half word (16 bits) data or a word (32 bits) data is accessed from boundaries other than a half word boundary (odd addresses) or that other than a word boundary, respectively.

4. Data Bus Error Exception

A process jumps to a specified address upon detection of an exception when a peripheral module has sent a bus error signal to a core logic for data access.

5. Instruction Bus Error Exception

A process jumps to a specified address upon detection of an exception when a peripheral module has sent a bus error signal to a core logic for instruction fetch.

6. Double Exception

A process jumps to a specified address different from an address to which the process would jump in normal error cases, in order to cope with a double-fault when an address error, a bus error, or suchlike, occur during a critical period while executing interrupt processing, or the like.

[2] Interrupt processing

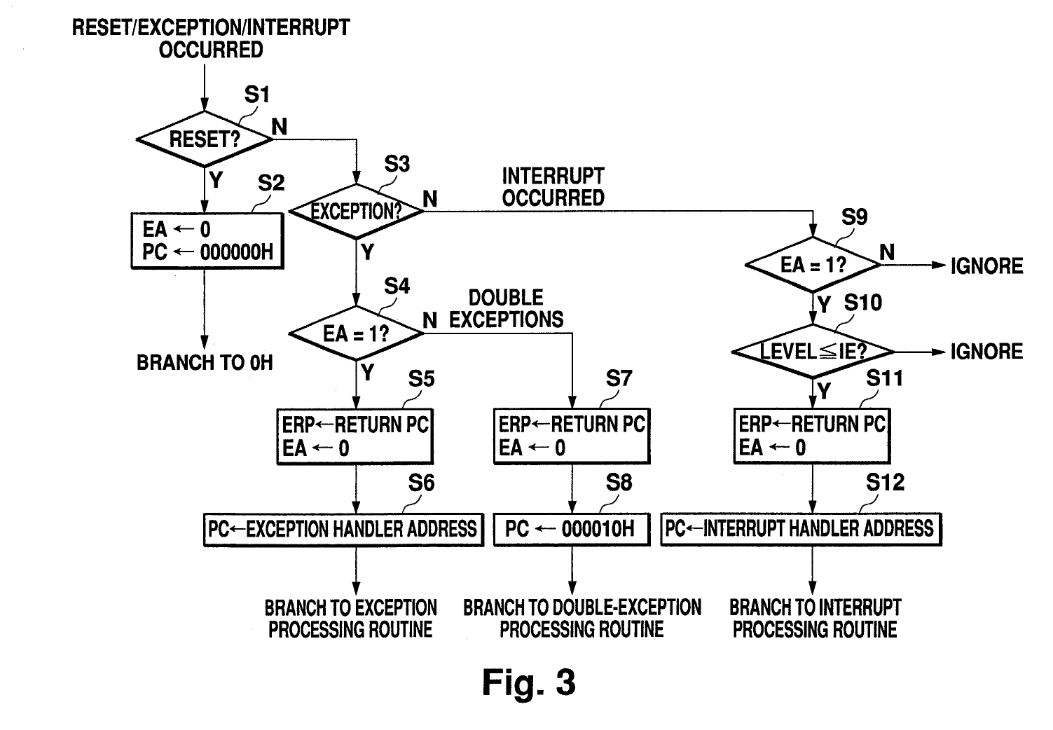

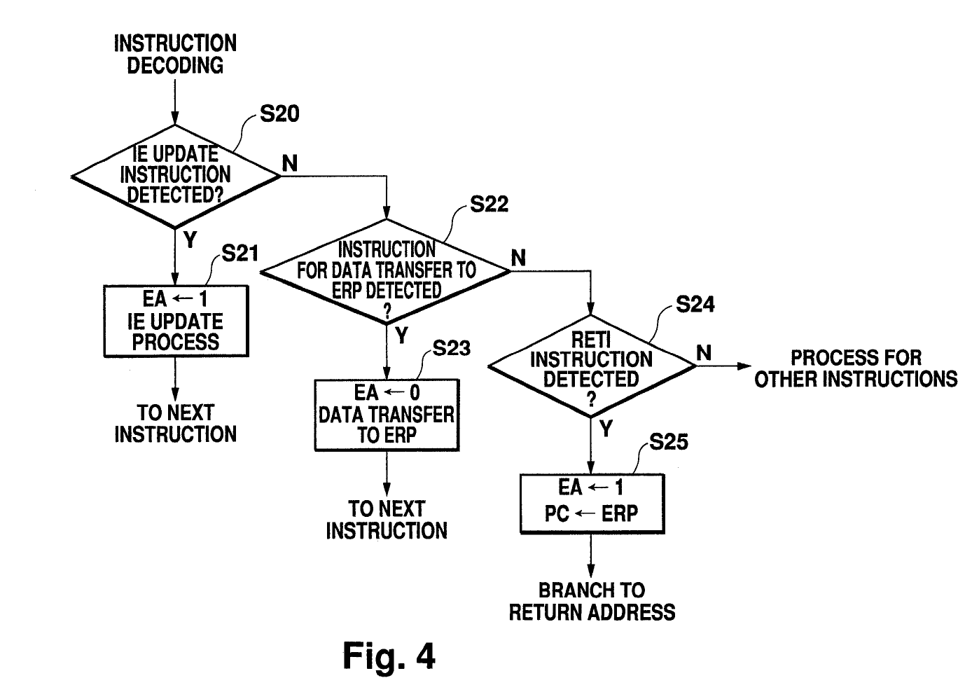

FIGS. 3 and 4 are flowcharts showing a processing procedure for an interrupt, or the like, carried out by the present apparatus. FIG. 3 relates to cases where any resets, exceptions, or interrupts occur. FIG. 4 relates to cases where the instruction decode/execution controller 3 detects specific instructions.

As shown in FIG. 3, when the apparatus is reset (S1), the EA flag is automatically cleared to be 0 and the PC value becomes 0. The process jumps to the address 0 (S2).

When an exception occurs (S3), provided that the EA flag is 1 (EA=1) (Y at S4), the PC value, which indicates a return address from exception processing, is transferred to the ERP, and the EA flag is automatically cleared (S5). The process then jumps to a predetermined exception handler address (S6). On the other hand, provided that the EA flag is 0 (EA=0) (N at S4) when an exception occurs, double exceptions are detected, and the process jumps to an address different from one to which the process would jump in normal exception processing (S7, S8).

When an interrupt is requested, it is accepted when the EA flag is 1 (EA=1) (Y at S9) and the LEVEL of that interrupt is equal to or smaller than the IE (LEVEL≦IE) (Y at S10). Otherwise, it is ignored. When the interrupt is accepted, the PC value, which indicates a return address from interrupt processing, is transferred to the ERP, and the EA flag is cleared (S11) thereby temporarily ignoring other interrupt requests. This is because the apparatus enters into a critical period upon completion of storing an address into the ERP. Thereafter, the process jumps to a predetermined interrupt handler address (S12).

With reference to FIG. 4, next described is an operation for detecting instructions after a process has branched to an interrupt processing routine, referring to a handler address. At the beginning of the processing routine, the return address stored in the ERP is transferred to a stack memory or a general register (this step is not shown) so that multiple interrupts are enabled again. When the return address is fully transferred and stored as above, the apparatus enters into a safe period.

If an instruction for changing the IE is detected thereafter (Y at S20), that instruction is executed, and the EA flag is automatically changed to 1 (S21). Interrupts are then enabled. The above changing of the IE status is generally performed at around the start of an interrupt processing routine so that only interrupts having a higher priority than that of the ongoing processing routine are accepted for multiple interrupt processing after the process has branched to the current processing routine.

When the apparatus allows multiple interrupts, it performs interrupt processing. With the processing complete, the apparatus executes an instruction for preparing the environment for process returning. To be more specific, a return address saved in a stack memory, or the like, is read therefrom to be restored in the ERP. The apparatus enters, once again, into a critical period. In the present embodiment, when an instruction for data transfer to an ERP is detected (Y at S22), that instruction is executed, and an EA flag is automatically set at 0 (S23). The apparatus then again, enters into the interrupt disable state.

The critical period ends at the moment when the process returns to the main routine. Thus, in the present invention, when an instruction for returning a process from an interrupt processing routine (an RETI instruction) is detected (S24), the EA flag is automatically set at 1 (S25).

### [Programming Examples]

FIG. 7 shows an example of programming for an interrupt processing routine executed by the present apparatus, wherein solid and dotted lines respectively represent critical and safe periods.

1. Entering Into Interrupt Processing

A critical period starts from the moment when an interrupt request is accepted. When a process branches to a processing routine, the ERP value is transferred to a general register R2 via an MOVS instruction. Completion of this instruction initiates a safe period. The EA flag is automatically set at 1 via the subsequent SETPR (set priority) instruction which is an instruction for updating an IE, enabling multiple interrupts. The hardware of the present invention is designed such that execution of an SETPR instruction triggers the setting of an EA flag.

2. Returning from Interrupt processing

When a value saved in the R2 is transferred to the ERP register at a MOVS instruction, the EA flag is automatically set at 0. For this, the hardware of the present invention is designed such that an EA flag is reset when the ERP register is designated as a destination register in executing a MOVS instruction. When the EA flag is reset, the apparatus enters into a critical period, and interrupt requests are thus ignored. When an RETI instruction is executed, the ERP register value is set in the PC, and the EA flag is set at 1. The apparatus then enters into a safe period. Interrupt requests are once again accepted. The present invention can be improved or modified as follows.

(1) Although an EA flag is set at 1 at a SETRR instruction in FIG. 7, it may be automatically thus set when execution of a preceding MOVS instruction is completed since a critical period actually ends thereupon. In such a case, however, handling of the EA flag may be started with some delay because the time necessary to complete saving of data may vary depending on the type of data storage (that is, a stack memory, a general register, a main memory, or the like).

(2) Similarly, although an SETPR instruction is explicitly used to prepare environment for enabling multiple interrupts in the above embodiment, this instruction may be implicitly used. To be more specific, the hardware may be designed such that an IE being 10, for instance, is automatically changed to be 9 at a predetermined time after the process has branched to a processing routine. In this structure, an EA is also set upon completion of automatic changing of the IE.

(3) In FIG. 7, although a MOVS instruction for data transferring to an ERP is used to reset an EA flag, it is not limited to this instruction. Any instructions which resultantly achieve data transfer to an ERP, such as an OR instruction, are applicable.

(4) An EA flag, provided within a status register (STA) in the present invention, may be designed such that it is either read/write or read only. By using a read only EA flag, it is possible to avoid erroneous overwriting of an EA flag. Such errors may occur when handling operation flags which are also in the status register (STAT) and has nothing to do with an interrupt, or the like.

As described above, according to the program execution method and an apparatus using this method, an LDSR instruction is unnecessary for handling an EA flag, or suchlike, since the EA flag, or suchlike, is handled automatically. As a result, the number of program steps and the program size can be reduced. Therefore, multiple interrupts can be effectively performed without the risk of destroying a return address during a critical period.

Further, it is unnecessary to use an LDSR instruction, or the like, for handling flags, which eliminates the need to form data to be transferred to an ERP while taking flag positions into account. Therefore, mask operations, or the like, become unnecessary, and programming errors are thus reduced.

Still further, an EA flag is handled by hardware at optimum timing, which can prevent external urgent interrupt signals from being unnecessarily delayed.

What is claimed is:

1. A program execution method for executing specific case processing, in addition to normal processing, according to a processing request, comprising steps of:
receiving a request for specific case processing during execution of the normal processing;
upon receipt of a request for specific case processing, temporarily inhibiting further receipt of a request for specific case processing and branching to a routine for the specific case processing and storing a return address for use in returning to the normal processing in address holding means;
saving the return address stored in the address holding means in address saving means during the routine; and
automatically allowing further receipt of a request for specific case processing when an instruction for preparing environment for allowing further receipt of a request is executed.

2. A program execution method as defined in claim 1, wherein the instruction for preparing the environment is an acceptable interrupt level setting instruction.

3. A program execution method for executing specific case processing, in addition to normal processing, according to a processing request, comprising steps of:
receiving a request for specific case processing during execution of normal processing;
upon receipt of a request for specific case processing, temporarily inhibiting further receipt of a request for specific case processing, and branching to a routine for the specific case processing and storing a return address for use in returning to the normal processing in address holding means;
saving the return address stored in the address holding means in address saving means during the routine;
executing the specific case processing while allowing further receipt of a request for specific case processing; and
automatically inhibiting further receipt of a request for specific case processing when an instruction for preparing environment for returning to the normal processing is executed after completion of the specific case processing.

4. A program execution method as defined in claim 3, wherein the instruction for preparing environment is an instruction for transferring a return address read from the address saving means to the address holding means.

5. A program execution apparatus comprising:
a setting section for setting allowance or rejection of receipt of a request for specific case processing, wherein
the receipt is automatically allowed irrespective of a current setting situation when an acceptable interrupt level setting instruction is executed.

6. A program execution apparatus comprising:
a setting section for setting allowance or rejection of receipt of a request for specific case processing;
an address holding section for storing a return address when a process branches to specific case processing; and
an address saving section for saving a return address stored in the address holding section; wherein
the setting section automatically rejects further receipt irrespective of a current setting situation when a return address read from the address saving section is stored in the address holding section.

7. A program execution apparatus for executing specific case processing, in addition to normal processing, according to a processing request, comprising:
a setting section for setting allowance or rejection of receipt of a request for specific case processing;
an address holding section for storing a return address when a process branches to specific case processing; and
an address saving section for saving a return address stored in the address holding section; wherein
the setting section temporarily inhibits further receipt of a request for specific case processing when a request for specific case processing is received during execution of the normal processing,
the process branches to a routine for the specific case processing and stores a return address in the address holding section,
the address saving section saves the return address stored in a return address holding section during execution of the routine, and
the setting section automatically allows further receipt of a request for specific case processing when an instruction for preparing the environment for allowing further receipt of a request is executed.

8. A program execution apparatus as defined in claim 7, wherein the instruction for preparing the environment is an acceptable interrupt level setting instruction.

9. A program execution apparatus for executing specific case processing, in addition to normal processing, according to a processing request, comprising:
a setting section for setting allowance or rejection of receipt of a request for specific case processing;
an address holding section for storing a return address when a process branches to specific case processing; and
an address saving section for saving a return address stored in the address holding section; wherein
the setting section temporarily inhibits further receipt of a request for specific case processing when a request for specific case processing has been received during execution of the normal processing,
the process branches to a routine for the specific case processing and stores a return address in the address holding section,
the address saving section saves the return address stored in a return address holding section during execution of the routine,
the specific case processing is executed while the setting section allows again the receipt of a request for specific case processing; and
the setting section automatically rejects further receipt of a request for specific case processing when an instruction for preparing the environment for returning to the normal processing is executed after completion of the specific case processing.

10. A program execution apparatus as defined in claim 9, wherein the instruction for preparing the environment is an instruction for transferring a return address read from the address saving section to the address holding section.

11. A program execution apparatus as defined in claim 5, wherein the setting section is a flag bit for setting by means of software.

12. A program execution apparatus for executing specific case processing, in addition to normal processing, according to a processing request, comprising:
an address holding section for storing a return address when a process branches to specific case processing;
an address saving section for saving a return address stored in the address holding section; and
a status discrimination section for discriminating between an update allowed state where the contents of the address holding section are allowed to be updated and an update inhibited state where it is inhibited; wherein
the program execution apparatus in the update inhibited state enters into the update allowed state when acceptable interrupt level setting instruction is executed.

13. A program execution apparatus for executing specific case processing, in addition to normal processing, according to a processing request, comprising:
an address holding section for storing a return address when a process branches to specific case processing;
an address saving section for saving a return address stored in the address holding section; and
a status discrimination section for discriminating between an update allowed state where the contents of the address holding section are allowed to be updated and an update inhibited state where it is inhibited; wherein
the program execution apparatus in the update allowed state enters into the update inhibited state when a return address is stored in the address holding section.

14. A program execution apparatus as defined in claim 12, wherein
the status discrimination section is a flag bit capable of being manipulated by software, and
the program execution apparatus shifts between the update allowed state and the update inhibited state by explicit or automatic re-writing of the flag bit.

15. A program execution apparatus as defined in claim 13, wherein
the status discrimination section is a flag bit capable of being manipulated by software, and
the program execution apparatus shifts between the update allowed state and the update inhibited state by explicit or automatic re-writing of the flag bit.

16. A program execution apparatus as defined in claim 14, wherein
the flag bit is provided in a status register accessible via an instruction for transferring data, and re-writing of the flag bit is inhibited even when an instruction for transferring data to the status register is executed.

17. A program execution apparatus as defined in claim 15, wherein
the flag bit is provided in a status register accessible via an instruction for transferring data, and re-writing of the flag bit is inhibited even when an instruction for transferring data to the status register is executed.
